(19) United States
(12) Patent Application Publication
(10) Pub. No.: US 2014/0358905 A1
(43) Pub. Date: Dec. 4, 2014

(54) System and Method for Answer Aggregation

(71) Applicant: David STEVENS, New York, NY (US)

(72) Inventor: David STEVENS, New York, NY (US)

(73) Assignee: UNLEASH THE CROWD INCORPORATED, New York, NY (US)

(21) Appl. No.: 13/903,486

(22) Filed: May 28, 2013

(51) Int. Cl. G06F 17/30

(52) U.S. Cl. CPC G06F 17/30991
USPC 707/723; 707/722

(57) ABSTRACT

A system and method of answer aggregation that receives a querying user supplied question, provides the user supplied question to multiple responding users, receives one or more answers to the question from responding users, performs an answer aggregation algorithm to generate a collective answer, and displays the collective answer.

### BACKGROUND

1. FIELD OF THE INVENTION

The present invention generally relates to systems and methods for social networking, and more particularly, social networking applications that aggregate answers to questions posted by users.

2. Discussion of the Related Art

In recent years, Internet-based social networking applications have been increasingly relied upon to communicate with friends, family, colleagues, and others. As a result, many social interactions that previously took place in person, on the phone, or via physical or electronic mail, now occur through such social networking applications. In a typical social networking application, a user engages with other users to share and/or discuss various aspects of their lives. For example, a user may share mundane topics (e.g., “I just got coffee”) as well as life changing events (e.g., “I just had a baby”). Users typically communicate with people they know, but anonymous and non-anonymous (e.g., profile based) communication is feasible.

In some instances, an example user may seek the answers of other users. In response to user generated questions, some question and answer systems have emerged. One example question and answer system is an invitation application. For example, invitation applications generally enable a user to invite others to a social event. Invitees are provided with possible reply choices (e.g., yes, no, or maybe). In another example, online polling systems enable users to vote for one of a plurality of pre-determined choices (e.g., “Who will be the next president?”).

In other instances, an example user may desire to ask more customized questions to other users (e.g., “Should I dump my girlfriend?”). To address more customized questions, users often rely on Internet-based forums. Here, a user posts a question to the forum, and other users may post answers to the question. Typically, the answers or comments of each user are listed beneath the original question, usually in the form of a list. In addition, users may vote for the answers of other users such that the various answers are listed in order of popularity. In other words, scores can be assigned to individual answers.

Unfortunately, existing question and answer systems have a number of drawbacks. For example, the use of an invitation application is limited to upcoming social events. Similarly, online polling systems tend to be implemented by institutional users, such as a news agency, not by individual users. In addition, the possible answer choices cannot be customized by responding users. Moreover, forum applications require manual aggregation of the answers, which can be quite time-consuming because no mechanism is provided for posting a question to multiple users and for providing a concise answer reflecting their collective answer. In other words, the user must manually sift through each of the answers to determine the best response.

Accordingly, the embodiments of the present invention provide a system and method for answer aggregation.

### SUMMARY

Accordingly, embodiments of the present invention are directed to a system and method for answer aggregation that substantially obviates one or more problems due to limitations and disadvantages of the related art.

Additional features and advantages of the embodiments of the present invention will be set forth in the description which follows, and in part will be apparent from the description, or may be learned by practice of the invention. The objectives and other advantages of the embodiments will be realized and attained by the structure particularly pointed out in the written description and claims hereof as well as the appended drawings.

To achieve these and other advantages and in accordance with the purpose of the present invention, as embodied and broadly described, the system and method for answer aggregation receives a querying user supplied question, provides the user supplied question to multiple responding users, receives one or more answers to the question from responding users, performs an answer aggregation algorithm to generate a collective answer, and displays the collective answer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this specification, illustrate embodiments of the invention and together with the description serve to explain the principles of the invention. In the drawings:

FIG. 1 illustrates a method for answer aggregation according to an example embodiment of the present invention;

FIG. 2 illustrates a system level architecture that depicts the interaction between a remote electronic device and a backend system according to an example embodiment of the present invention;

FIG. 3 illustrates a method for aggregating a plurality of answers according to an example embodiment of the present invention;

FIG. 4 illustrates a representative view of a remote electronic device having an aggregation application according to an example embodiment of the present invention;

FIG. 5(A) illustrates a representative view of a user preferences menu according to example embodiment of the present invention;

FIG. 5(B) illustrates a representative view of a user preferences menu according to another example embodiment of the present invention;

FIG. 6(A) illustrates a representative view of an answering module of an aggregation application according to an example embodiment of the present invention;

FIG. 6(B) illustrates a representative view of an answering module of an aggregation application according to another example embodiment of the present invention; and

FIG. 6(C) illustrates a representative view of an answering module of an aggregation application according to yet another example embodiment of the present invention.

### DETAILED DESCRIPTION

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that the present invention may be practiced without these specific details. In other instances, well-known methods, procedures, components, and circuits have not been described in detail so as not to unnecessarily obscure aspects of the embodiments. Wherever possible, like reference numbers will be used for like elements.

Embodiments of user interfaces and associated methods for using an electronic device are described. In some embodiments, the device is a portable communication device (e.g., a mobile phone or tablet). The user interface may include a touch screen and/or other input/output devices. In the discussion that follows, a portable communications device is used as an example embodiment. It should be understood, however, that the user interfaces and associated methods may be applied to other devices, such as personal computers and laptops, which may include one or more other physical user-interface devices, such as a keyboard and or mouse.

The portable communication device may support a variety of applications, such as telephone, text messenger, answer aggregation applications, and social networking applications. The various applications that may be executed on the device may use at least one common physical user-interface device. In other words, a common physical architecture of the device may support a variety of applications. In the discussion that follows, an answer aggregation application and/or social networking application are used as example embodiments, but it should be understood that the user interfaces and associated methods may be applied to other applications.

Embodiments of the present invention are directed to methods and systems for answer aggregation. The described methods and systems may utilize a variety of algorithms to perform answer aggregation. In one embodiment, a variant of the Condorcet algorithm is applied, but the invention is not limited to any particular algorithm. An answer aggregation engine analyzes answers originating from multiple responding users to generate their collective answer to a posted question in real-time.

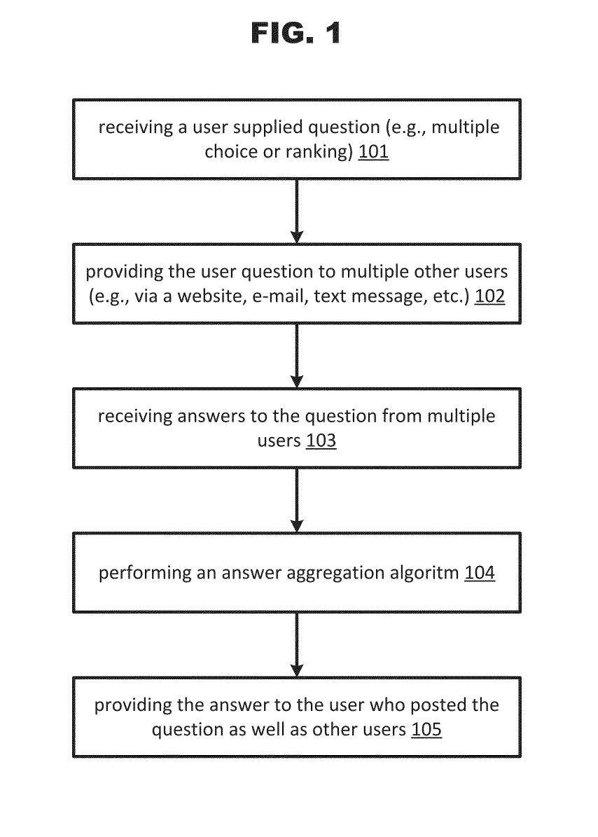

FIG. 1 illustrates a method for answer aggregation according to an example embodiment of the present invention.

Initially, the example answer aggregation application may require that a user provide a login name and login password to access the application. The login name and login password can be adapted to identify individual users associated with the application or a particular question or answer. For example, each user of the aggregation application may have a profile page. Within the profile page, a user may post his or her picture and account name. The profile page may display the questions that a user has posted as well as the questions answered by the user. Similarly, the profile page may enable the user to navigate questions posted by other users as well as their profile pages. In addition, a user may search questions by category (e.g., sports, health, politics, etc.) and access a user preferences menu. In other instances, a user may be provided with an option to post questions and answers anonymously.

The answer aggregation application may be a standalone application, or may be integrated into a social networking or other application. In addition, the answer aggregation application may be accessible through a website, a mobile application, or an e-mail application.

At 101, a backend system, such as a server, receives a question supplied by a querying user. In advance of broadcasting the question to a plurality of responding users, a querying user may first select a question type from a variety of question and answer formats. For example, the question may be multiple-choice or may require respondents to rank a plurality of answer choices. Here, a user posting a question may also propose a set of pre-defined answers. Alternatively, or in addition, the backend system may also suggest or automatically assign one or more answer choices. In yet another alternative, a querying user may designate that answer choices are proposed, in part or entirely, by responding users.

In a basketball example, a user can supply to the backend system a multiple choice question, such as “Who is the greatest basketball player of all time?” with possible choices of “Kobe Bryant,” “Michael Jordan,” and “Wilt Chamberlain.” Alternatively, a user may ask a “ranking question,” which queries respondents to rank order a possible set of choices. In another basketball example, a question could be “Rank the following basketball players in order of greatness” and possible choices could be “Kobe Bryant,” “Michael Jordan,” and “Wilt Chamberlain.”

In some instances, a user may designate or “tag” a question as relevant to one or more or pre-defined categories, such as sports, politics, current events, health, cooking, etc. In the basketball example, the questions described above could be designated within a sports category by a querying or responding user. Alternatively, the backend system may also suggest or automatically assign categories.

In addition to posting a question and proposing possible answer choices, the user posting the question can also provide an associated data object, such as text, an image, a video, a link to a website, etc. In the basketball example, a link may be provided to a website containing each of the basketball players' official statistics. In another example, a querying user may also upload a video clip to the backend system of one or more of the basketball players. In yet another example, the question may be included within the text, image, or video. At the backend system, the associated data object may be subject to limitations, such as data size, image size, duration, or character length.

In another example, the question may be related to the content of the associated data object (e.g., a website link may be associated with a question, such as “do you agree with this article?”). Here, a querying user may provide a website link. Alternatively, a querying user may be connected to the aggregation application by selecting an aggregation icon at a website. In the latter case, the aggregation application may automatically populate one or more data object fields, such as a website URL, for a querying user.

The answer aggregation application may also include a preferences menu that enables a user to designate a variety of rules in connection with posted questions. In other words, a querying user may subject responding users to one or more rules for answering a posted question. For example, the user posting a question may allow other users or the backend system to propose answer choices. In another example, the querying user may set a question expiration time such that only answers received by a selected time will be aggregated.

Alternatively or in addition, the answer aggregation application may impose some pre-defined rules on querying and responding users alike. For example, the question length may have a character limit, such as 128 characters. Similarly, answers may also have a character limit, such as 64 characters. In another example, the number of possible answer choices can also be limited not to exceed a predetermined number.

At 102, the backend system provides the question of the querying user to multiple other users, as potential responding users. Through the preferences menu, the user posting the question may designate a set or subset of other users to receive the question. In addition, or alternatively, a querying user may also designate a subset of potential users (i.e., viewers who may then become users) to view the question. Here, the querying user may restrict who can view the question as well as who may answer the question. Alternatively, the querying user may allow the question to be open anyone who can view the aggregation application, but may restrict responding users to a smaller set of users and/or potential users.

Numerous groupings of users may be designated as potential question respondents. For example, a user may designate to post the question to all active users of the aggregation application. In another example, the querying user may designate to ask other users who have expressed an interest in a particular category, such as sports. In this example, individual users may express an interest in a particular category and a desire to receive category related questions through their respective user preferences. In another example, users accessing the aggregation application through specified mediums, such as mobile users, may be queried. In yet another example, a user may identify specific individual users by usernames, mobile phone numbers, or e-mail addresses to be queried. In yet another example, a user may designate predefined groups or circles of other users (e.g., “friends” may be one group, and “colleagues” may be another group). Here, the groups or circles may be designated in the aggregation application, or through another social media application (e.g. followers on Twitter, or friends on Facebook and/or Google+, etc.).

In addition, the answer aggregation application may also employ GPS features of a mobile device to query users within or about a particular geographic area. For example, a user seeking a good restaurant may query active users within a five mile radius by asking “What is the best restaurant in this area?”

The backend system may transmit questions to potential responding users through a variety of communication mediums. To distribute a question to multiple users, the backend system may communicate the question by e-mail, social media message, social media accounts and profiles, text message, etc. Alternately, users interacting with the aggregation application may view pending questions, and may proceed to answer a pending question, if desired.

As described above, the answer aggregation application may be a standalone application or may be integrated into a social networking application. When operating as a standalone application, the answer aggregation application can also be connected or linked to other applications, such as a social networking, e-mail, Web-TV, or SMS applications. For example, the answer aggregation application may provide a link that can be selected or “clicked on” from another application, such as a social networking, e-mail, or Web-TV application. In the Web-TV example, or a traditional television, a question and answer banner may be superimposed on a portion of the television display such that people watching a program are presented with a question and prompted to respond through the television or Web-TV application.

In some instances, the answer aggregation application may provide an embedded data object including the question and possible answer choices. The embedded data object can be adapted to connect with the backend system of the answer aggregation application, and may do so in a manner that appears seamless to the responding users. In addition, the answer aggregation application may be accessible through a website, or through a mobile application.

Next, at 103, the backend system receives answers from multiple responding users. Once presented with a question, each of the multiple users who received the question may provide their respective answers.

Referring back to the basketball question example, responding users may select a single answer choice (i.e., the “best choice”) in a multiple-choice type question. In a ranking type question, instead of choosing a “best choice” (i.e., selecting only one choice), the user may rank the choices. For example, by assigning a “1” to “Michael Jordan,” a “2” to “Wilt Chamberlain” and a “3” to “Kobe Bryant.” Sometimes, a user may indicate a tie (e.g., assign a “1” to both “Michael Jordan” and to “Kobe Bryant”). In another example, users can leave out certain choices when ranking (e.g., rank “Michael Jordan” with a “1” and leave null values for “Kobe Bryant” and “Wilt Chamberlain”).

In some instances, responding users can select one of the existing multiple choice answers to the question. In other instances, responding users may be allowed to propose one or more additional answer choices. In yet other instances, the querying user may designate that all answer choices be provided by responding users. In either case, the number of answer choices may be limited to a predetermined number by the querying user or the backend system. Optionally, responding users may also provide a data object such as a website link, image, video, or text statement. Similar to the data object provided by querying users, the associated data object may be subject to limitations, such as data size, image size, duration, or character length.

In some embodiments, users may also assign positive or negative status points (e.g., “thumbs up” or “thumbs down”) to the querying user. Similarly, users may also assign positive points to other users who have posted insightful remarks or negative points to users who post trivial remarks. Accumulation of these status points can be used to determine a user's rank that defines a user's social status on the social network or aggregation application.

At 104, the backend system performs an answer aggregation algorithm. Here, the backend system collects user answers and aggregates them into a succinct single answer, representing a collective answer of the responding users.

For multiple choice questions, in which a single answer choice is selected by each responding user, the applied algorithm may display the results sorted by the choices receiving the greatest percentage of votes cast. For ranking type questions, the backend algorithm may apply a ranking algorithm to determine the aggregated ranking of the responding users.

The aggregation application may utilize a variety of algorithms to perform answer aggregation. In some example embodiments, the Condorcet algorithm or a variant of the Condorcet algorithm is applied, but other algorithms may also be used. Within the backend system, an answer aggregation engine analyzes answers originating from responding users to generate their collective answer to a posted question. Although the Condorcet and other ranking algorithms are computationally intensive, a collective answer can still be provided in real-time.

In the basketball question example, the backend system compiles all of the user inputs and aggregates them into a collective answer (e.g., “1: Michael Jordan, 2. Kobe Bryant, and 3. Wilt Chamberlain”). Without an algorithm, the compilation of potentially thousands of views on the ranking into one final ranking set would be cumbersome and not scalable.

At step 105, the backend system provides the aggregated answer to the querying user as well as other users of the aggregation application. In addition, the question and aggregated answer may also be provided to social networking and/or other applications, if desired. For example, a user may link a social networking application to the aggregation application such that the aggregation mechanisms may be applied to a question, and the result displayed on the social network.

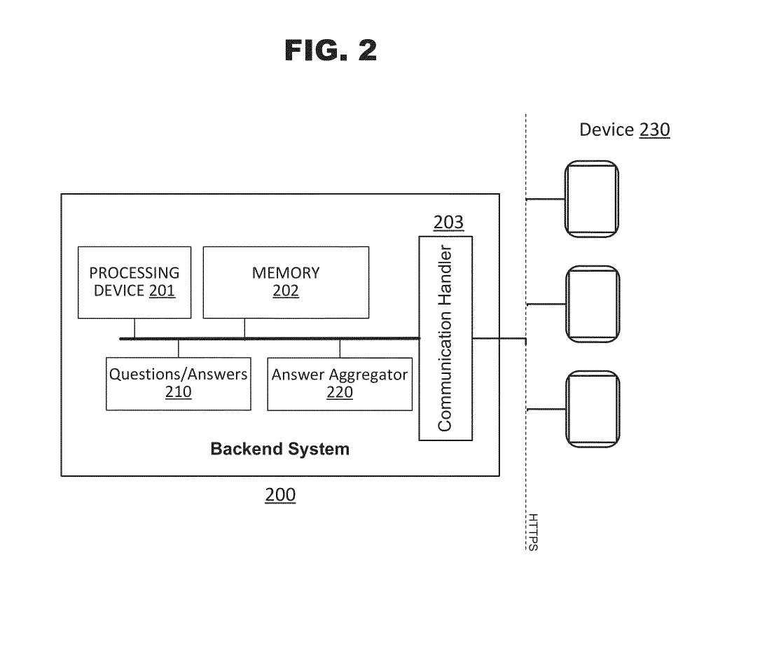

FIG. 2 illustrates a system level architecture that depicts the interaction between a backend system and a remote electronic device according to an example embodiment of the present invention.

Backend system 200 generally implements the functions of an answer aggregation algorithm or social networking application that integrates answer aggregation features. As shown in FIG. 2, backend system 200 may include a processing device 201, memory 202, communication handler 203, questions and answers storage unit 210, and an answer aggregator 220, all of which may be interconnected via a system bus.

Processing device 201, such as a central processing unit (CPU), may perform computation and control functions of the backend system 200. Processing device 201 may include a single integrated circuit, such as a microprocessing device, or may include any suitable number of integrated circuit devices and/or circuit boards working in cooperation to accomplish the functions of a processing device. Processing device 201 may execute computer programs, such as object-oriented computer programs, within memory 202.

Memory 202 may include a computer readable medium storing application modules, which may include instructions associated with answer aggregation and/or social networking applications as well as other modules of the backend system 200. Memory 202 may include various components for retrieving, presenting, changing, and saving data and may include computer readable media. Memory 202 may include a variety of memory devices, for example, Dynamic Random Access Memory (DRAM), Static RAM (SRAM), flash memory, cache memory, and other memory devices. In some instances, memory 202 and processing device 201 may be distributed across multiple different computers that collectively comprise the backend system 200. Alternatively or in addition, user question and answers as well as user preferences can be stored in memory 202 or in a dedicated memory, such as questions and answers storage unit 210. Backend system 200 includes one or more databases 210 that store several types of information including user questions and answers, account information, and user preferences.

The backend system 200 can be connected to the remote electronic devices 230 using known or expected network technologies, such as wireless local area networks (WLAN) or wireless wide area networks (WWAN), some examples of which include WiFi, long term evolution (LTE), and the like. Communication handler 203 manages communication functions for the backend system 200. In the various embodiments, the backend system 200 may have an architecture with modular hardware and/or software systems that include additional and/or different systems communicating through one or more networks via communications device 203.

Answer aggregator 220 includes software and/or hardware modules that implement one or more answer aggregation algorithms. In one example embodiment, a variant of the Condorcet algorithm is applied, but other algorithms may also be applied. Within the backend system 200, answer aggregator 200 analyzes answers originating from responding users to generate their collective answer. The aggregated answer can be displayed to the querying user as well as other users of the aggregation application in real-time or in a reasonably short time.

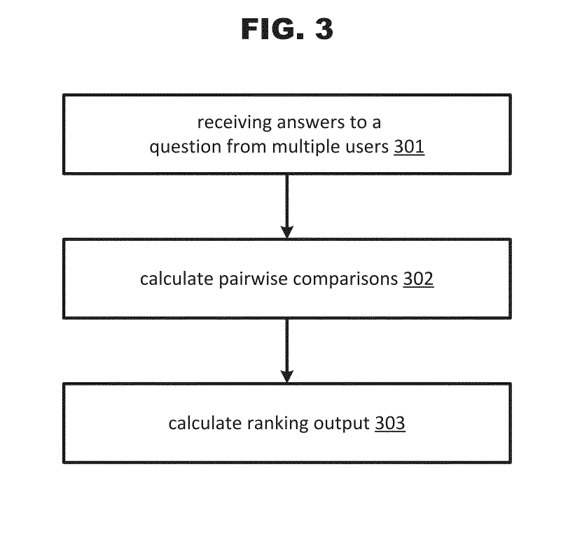

FIG. 3 illustrates a method for aggregating a plurality of answers according to an example embodiment of the present invention. In this example embodiment, a ranking algorithm, such as Condorcet, Schulze, etc., is applied to a ranking type question. An example Schulze method is describe in an article entitled, “A New Monotonic, Clone-Independent, Reversal Symmetric, and Condorcet-Consistent Single-Winner Election Method”, which is hereby incorporated by reference. For multiple choice type questions, the collective answer may be the answer choice receiving the most or a majority of votes. In addition, the distribution of answers selected by responding users may be displayed to querying and responding users alike.

Initially, at 301, the backend system receives answers from multiple users. Upon receiving a ranking type question, each of the responding users may provide their respective rankings of the possible answer choices. Rankings may be provided in a variety of formats including best to worst, worst to best, first to last, etc. In addition, a responding user may indicate a tie between two or more of the possible answer choices. In the event that one or more answer choices is omitted by a responding user, the backend system may assume a worst or last place ranking of the omitted answer choice(s).

Next, at 302, the backend system performs pairwise comparisons between each possible pairing of answer choices. Referring back to the basketball question example, there may be 20 responding users who prefer Michael Jordan to Kobe Bryant, and 10 responding users who prefer Kobe Bryant to Michael Jordan. In this example, Michael Jordan wins compared to Kobe Bryant. For each pairing, the number of responding users who prefer an answer choice (e.g., one basketball player) to another answer choice (e.g., another basketball player) is counted.

Lastly, at 303, the backend system calculates the collective ranking of the possible answer choices based on the pairwise comparisons calculated at 402. Here, a pairwise comparison may be based on a strongest or weakest pairwise comparison. For example, when comparing Michael Jordan to Kobe Bryant, there may be 10 responding users who prefer Michael Jordan to Kobe Bryant, and 18 responding users who prefer Michael Jordan to Wilt Chamberlain, and 15 users who prefer Wilt Chamberlain to Kobe Bryant. In the example, the strongest pairwise comparison between Michael Jordan and Kobe Bryant would be 15 and the weakest pairwise comparison would 10.

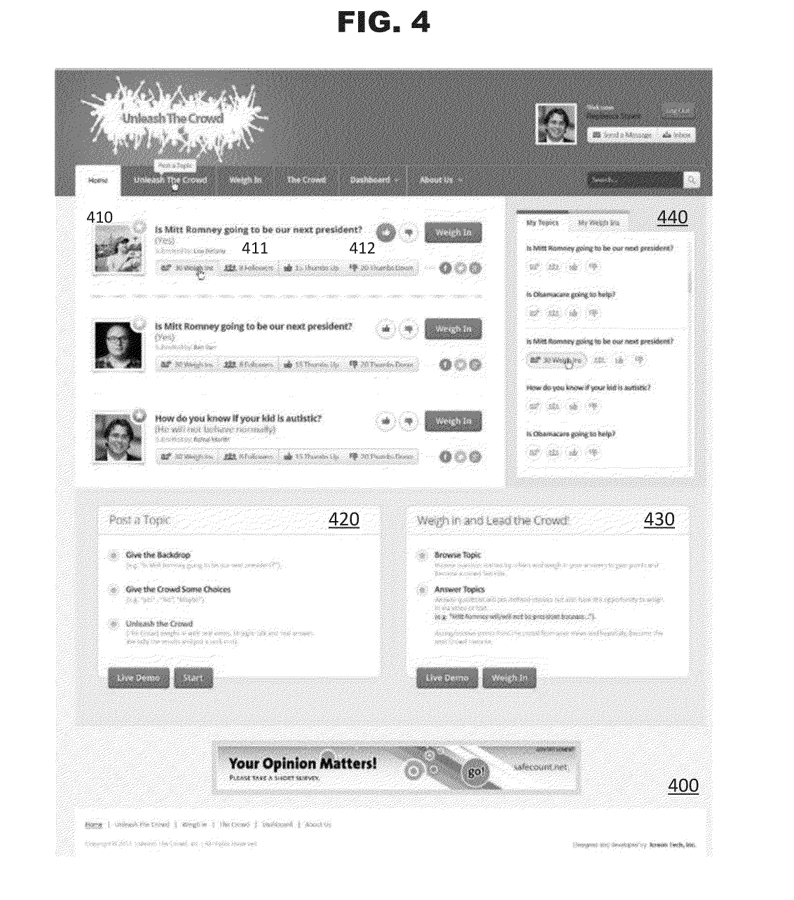

FIG. 4 illustrates a representative view of a remote electronic device having an answer aggregation application according to an example embodiment of the present invention. The representative view 400 includes a question and answer display section 410, a posting section 420, an answering section 430, and a tracking section 440. In example question and answer display section 410, an aggregated answer 412 is displayed adjacent to its respective question 411. In addition, other information, such as the number of respondents, number of users following the question, and the user's social ranking can also be displayed. Posting section 420 provides users with one or more menus to submit question(s) and to propose answer(s) to existing questions. Answering section 430 provides users with one or more menus to browse questions, such as browsing by topic, and one or more menus to submit answers to existing questions. Tracking section 440 enables users to track questions that they have posted as well as track questions of other user that they have answered.

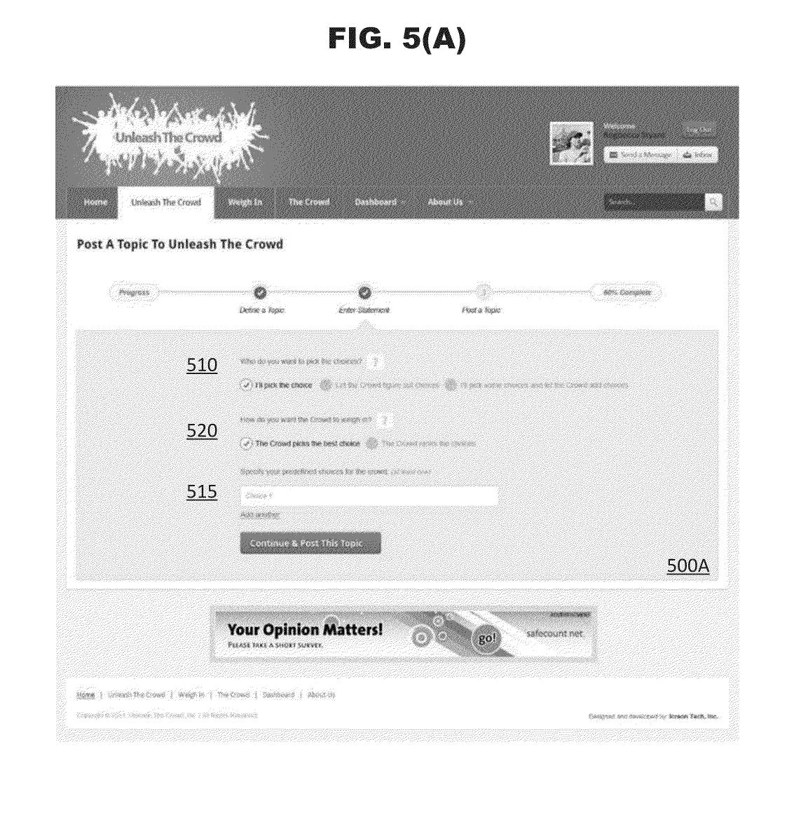

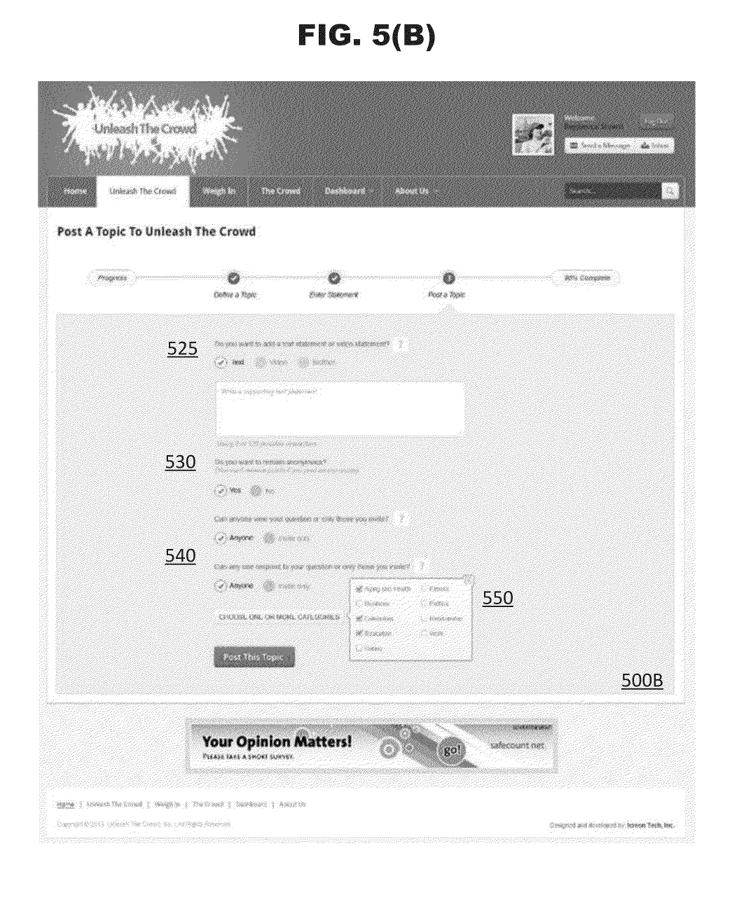

FIG. 5(A) illustrates a representative view of a user preferences menu according to an example embodiment of the present invention. The example preferences menu 500A includes an answer preferences menu 510 and a question preferences menu 520.

In example answer preferences menu 510, a querying user may set one or more rules that govern the answering of a question by responding users. For example, the querying user may elect to propose the answer choices and/or allow other users to propose answer choices. In another alternative, a querying user may also allow the backend system to propose answer choices. In cases where the querying user selects to propose answer choices, such answer choices may be added through answer adding section 515.

In example question preferences menu 520, a querying user may set one or more rules that govern the question. For example, a querying user may define the question as either a multiple choice or a ranking type question. In another example, the querying user may set a question expiration time such that only answers received by a selected time will be aggregated.

FIG. 5(B) illustrates a representative view of a user preferences menu according to another example embodiment of the present invention. The example preferences menu 500B includes a data object section 525, a user anonymity section 530, an invited user section 540, and a category section 550.

In example data object section 525, a querying user can associate a data object with a question. The optional data object may include one or more of a text string, video file, or a link to a website. In some instances, a querying user may desire to upload a video of him/herself asking the question. Here, a video file may be generated through another application, or directly through the answer aggregation application. The backend system may impose restrictions on the data object, such as data size, duration, or character length.

Example user anonymity section 530 enables a querying user to post a question in either an anonymous or non-anonymous manner. When posting questions or answers in a non-anonymous manner, a user may be identified by an account name. In addition, each user having an aggregation application account may also have a profile page. Within an example profile page, other users may view a particular user's posted questions and answers as well as categories of interest.

Additionally, example invited user section 540 enables a querying user to designate a set or subset of other users who may view and/or respond to a posted question. As discussed above, several groupings of responding users may be defined.

A querying user may also designate or “tag” a question as relevant to one or more or pre-defined categories, such as sports, politics, current events, health, cooking, etc. A querying (or responding) user may indicate that a question relates to one or more categories through example category section 550. Alternatively, the backend system may also suggest or automatically assign categories to posted questions.

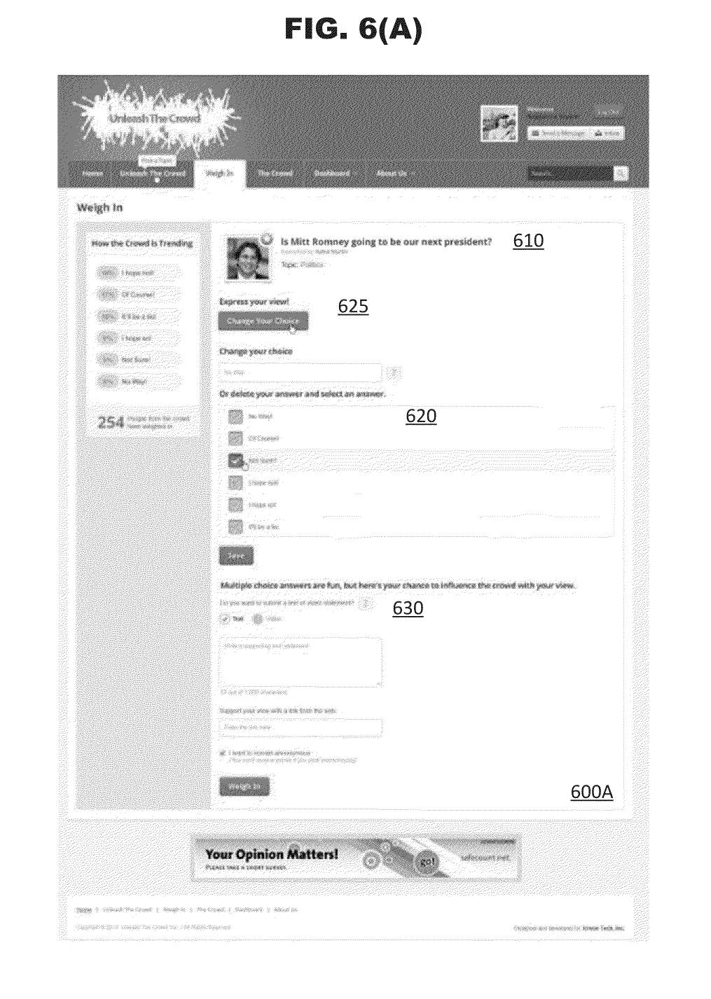

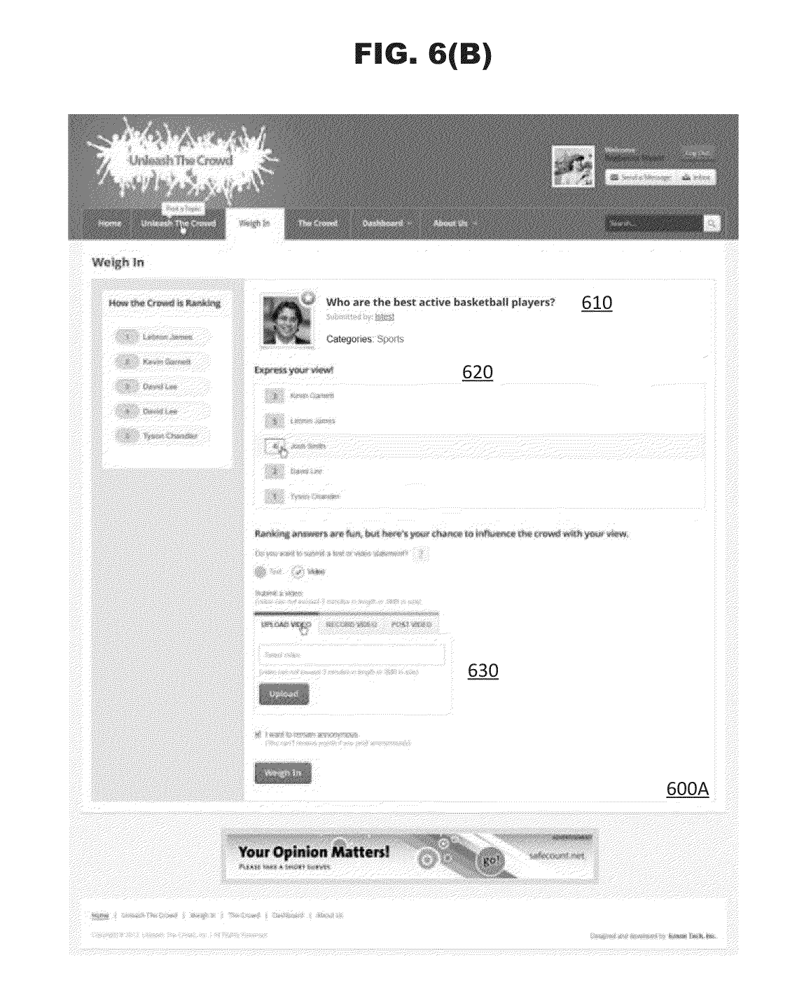

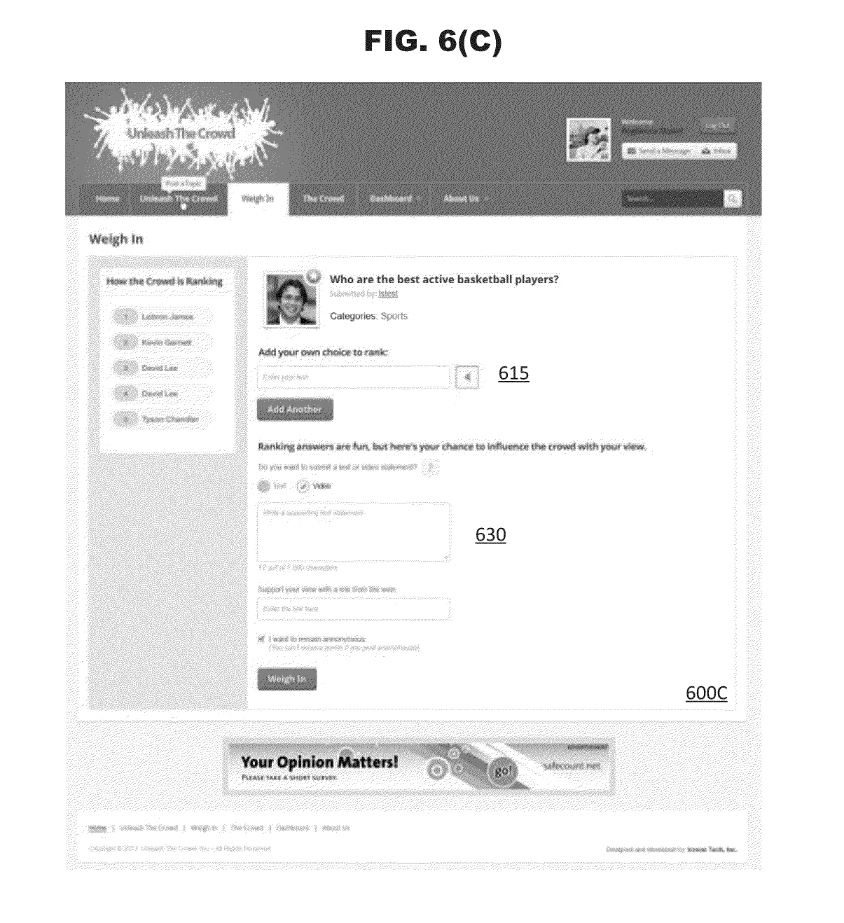

FIG. 6(A) illustrates a representative view of an answering module of an aggregation application according to an example embodiment of the present invention. The example answering module 600A includes question section 610, answering section 620, and answer data object section 630. Example question section 610 recites and/or displays a question to a potential responding user. Using answering section 620, a responding user may enter his or her answer to either a multiple choice or ranking type questions. In FIG. 6(A), a multiple choice question is shown. In some instances, a responding user may desire to change an already submitted answer, and the responding user may delete an already submitted answer through change module 625. In addition, a responding user may also submit a data object such as a link, video, or text statement through answer data object section 630. Here, a text data object is selected. Similar to the data object provided by querying users, the data object may be subject to limitations, such as data size, duration, or character length.

FIG. 6(B) illustrates a representative view of an answering module of an aggregation application according to another example embodiment of the present invention. Although answering module 600B is similar to answering module 600A, a ranking question is depicted in question section 610 and a video data object is selected in answer data object section 630 of FIG. 6B.

FIG. 6(C) illustrates a representative view of an answering module of an aggregation application according to yet another example embodiment of the present invention. As discussed above, responding users may be allowed to propose one or more additional answer choices. When allowed to propose a new answer choice, a responding user may do so through answer adding section 615. Here, the backend system may limit the addition of answer choices not exceed a predetermined number. In addition, the backend system may automatically remove irrelevant answer choices proposed by responding users (e.g., Queen Elizabeth is not an acceptable answer to a best basketball player question). Alternatively, the backend system may flag potentially irrelevant answer choices, and allow the querying user to select whether or not a proposed answer choice remains as an answer choice.

There are numerous possible applications for the answer aggregation application. In one example, querying users can post a picture and ask responding users to propose a caption for the picture. Here, the backend system would aggregate responses and determine the best caption. In another example, schools, groups, organizations, or just a group of people can propose and vote for office candidates (e.g., treasurer of a yearbook committee). Similarly, communities can host debates on local activities and aggregate views. In addition, competitions like American Idol could be hosted on the aggregation application, and responding users may weighs-in on questions posted by the program. Any TV program that wants to ask a polling type question could simply display their URL (e.g., www.unleashthecrowd.com/AmericanIdol) and respondents could vote. An application programming interface (API) function can be adapted to display question answers on the TV display in real-time. In addition, advertisers may target advertisements to specific categories of questions (e.g., sports, health).

Although, as the old adage states, “two heads are better than one,” an aggregation application that effectively queries multiple users to determine a collective answer has not been until now. Recently, journalist and author James Surowiecki studied this wise saying in his book entitled the “The Wisdom Of Crowds”. He concluded that groups of people can be very intelligent, even more intelligent than their smartest member. Collectively, a wise group encompasses a diverse range of opinion as well as specialized knowledge of some of its members. Surowiecki attributes the wisdom of groups, in part, to need to resolve disagreements between group members so that a collective decision can be reached. Accordingly, in addition to collecting answers from responding users, the aggregation application disclosed herein also enables the querying user to take advantage of group wisdom to make decisions, design strategies, and solve problems. The aggregation application provides a platform for diverse opinions to be expressed, and an aggregation mechanism through which individual opinions are turned into a collective answer.

It will be apparent to those skilled in the art that various modifications and variations can be made in the system and method for answer aggregation of the present invention without departing from the spirit or scope of the invention. Thus, it is intended that the present disclosure cover the modifications and variations of this disclosure provided they come within the scope of the appended claims and their equivalents.

I claim:

1. A method comprising:
receiving a querying user supplied question;
providing the user supplied question to the identified responding users;
receiving one or more answers to the question from responding users;
performing an answer aggregation algorithm to generate a collective answer; and
displaying the collective answer.

2. The method of claim 1, wherein the querying user supplied question is a ranked order type question.

3. The method of claim 2, wherein the aggregation algorithm applies a method using pairwise comparisons.

4. The method of claim 1, wherein a data object is associated with the querying user supplied question.

5. The method of claim 1, further comprising:
generating an answer set for the querying user supplied question.

6. The method of claim 6, further comprising:
adding an answer choice to the answer set based on user input.

7. A non-transitory computer readable storage medium storing one or more programs configured to be executed by a processor, the one or more programs comprising instructions for:
receiving a querying user supplied question;
assigning the querying user supplied question to one or more categories;
identifying a set of responding users;
providing the user supplied question to the identified responding users;
receiving one or more answers to the question from responding users;
performing an answer aggregation algorithm to generate a collective answer; and
displaying the collective answer.

8. The computer readable storage medium of claim 7, wherein the querying user supplied question is a multiple choice type question.

9. The computer readable storage medium of claim 7, wherein the querying user supplied question is a ranked order type question.

10. The computer readable storage medium of claim 7, wherein a data object is associated with the querying user supplied question.

11. The computer readable storage medium of claim 7, further comprising instructions for:
generating an answer set for the querying user supplied question.

12. The computer readable storage medium of claim 11, further comprising instructions for:
adding an answer choice to the answer set based on user input.

13. A system comprising:
one or more process; and
a memory storing one or more programs for execution by the one or more process, the one or more programs including instructions for:
receiving a querying user supplied question;
assigning the querying user supplied question to one or more categories;
identifying a set of responding users;
providing the user supplied question to the identified responding users;
receiving one or more answers to the question from responding users;
performing an answer aggregation algorithm to generate a collective answer; and
displaying the collective answer.

14. The system of claim 13, wherein the querying user supplied question is a multiple choice type question.

15. The system of claim 13, wherein the querying user supplied question is a ranked order type question.

16. The system of claim 13, wherein a data object is associated with the querying user supplied question.

17. The system of claim 13, further comprising instructions for:
generating an answer set for the querying user supplied question.

18. The system of claim 17, further comprising instructions for:
adding an answer choice to the answer set based on user input.
